(19) United States
(12) Patent Application Publication
(10) Pub. No.: US 2026/0138446 A1
(43) Pub. Date: May 21, 2026

(54) LAMINATED PANE FOR A PROJECTION ARRANGEMENT

(71) Applicant: SAINT-GOBAIN GLASS FRANCE, COURBEVOIE (FR)

(72) Inventors: Julian GREVERATH, HERZOGENRATH (DE); Jan HAGEN, HERZOGENRATH (DE); Andreas GOMER, HERZOGENRATH (DE); Valentin SCHULZ, HERZOGENRATH (DE)

(21) Appl. No.: 18/705,778

(22) PCT Filed: Dec. 1, 2022
(86) PCT No.: PCT/EP2022/084034

§ 371 Date: Apr. 29, 2024

(30) Foreign Application Priority Data
Dec. 15, 2021 (EP) 21214580.9

(51) Int. Cl. B60K 35/23; B32B 17/10; B60J 1/00

(52) U.S. Cl. CPC B60K 35/23; B32B 17/10036; B32B 17/10348; B32B 17/1044; B32B 17/10935; B60J 1/001; B32B 2250/05; B32B 2307/416; B32B 2605/00

(57) ABSTRACT

A laminated pane includes an outer pane, a masking layer, a first thermoplastic intermediate layer, an optical multilayer film which has a portion designed as a concave mirror, a second thermoplastic intermediate layer and an inner pane, wherein the optical multilayer film is arranged between the outer pane and the inner pane, the first thermoplastic intermediate layer is arranged between the outer pane and the optical multilayer film, the second thermoplastic intermediate layer is arranged between the optical multilayer film and the inner pane, the masking layer is arranged between the outer pane and the optical multilayer film in a region of the laminated pane, and wherein at least the portion of the optical multilayer film designed as a concave mirror is arranged in a region of the laminated pane, which region is completely within the region in which the masking layer is arranged when viewed through the laminated pane.

The invention relates to a laminated pane for a projection assembly, to a method for the production thereof, to the use thereof, and to a projection assembly.

Modern automobiles are increasingly equipped with so-called head-up displays (HUDs) as are known, for example, from DE 10 2009 020824 A1. With a projector, typically in the area of the dashboard, images are projected onto the windshield, reflected there, and perceived by the driver as a virtual image behind the windshield (as seen by the driver). Thus, important information can be projected into the field of vision of the driver, for example, the current travel speed, navigation messages or warnings that the driver can perceive without having to turn his gaze away from the road. Head-up displays can accordingly contribute substantially to increasing traffic safety.

US 2019/0299752 A1 discloses a laminated pane for a head-up display and EP 0 844 507 A1 discloses a head-up display system.

However, head-up displays often have the problem that the region of the windshield which is provided for reflection of the light projected by the projector has to have a high transparency of generally at least 70%. The reflected light of the projector is thus overlaid with light from the external environment, which, depending on the light conditions, can lead to a reduction in contrast of the virtual image and thus to a poorer visual perception for the driver. A sufficient visual perception of, in particular, safety-relevant information such as lane assistance, speed display or rotational speed of the motor should be ensured in all weather and light conditions. It would thus be desirable to have a projection assembly which is based on the head-up display technology in which no undesired secondary images occur and the arrangement of which is relatively easy to accomplish with good visibility with sufficient brightness and contrast of the displayed image information. In order to achieve this, it is necessary to increase the contrast in the reflection region of the windshield. The contrast increase can be achieved, for example, by the background of the reflection region being largely or completely opaque.

In addition, head-up displays often have the problem that the position of the imaging unit is specified by the geometry and the angle of inclination of the laminated pane. In order to enlarge the virtual image, the distance of the imaging unit from the windshield can be changed or the size of the imaging unit can be increased.

WO 2020/136646 A1 discloses a multilayer thin optical combiner which is configured to expand a view of the real world with virtual images and which was applied to the surface of a large transparent window.

U.S. Pat. No. 5,598,175 A discloses a display device in a vehicle which has a display device for displaying vehicle information, a hologram plate with a reflection function that is attached in the lower region of a windshield, wherein the hologram plate deflects display light from the display device to the driver of the vehicle, and a dark part which is attached to the rear side of the hologram plate in a shielding manner against external light penetrating it.

The object of the present invention is to provide an improved laminated pane for a projection assembly.

The object of the present invention is achieved according to the invention by a laminated pane according to claim 1. Preferred embodiments are apparent from the dependent claims.

The invention relates to a laminated pane at least comprising an outer pane, a masking layer, a first thermoplastic intermediate layer, an optical multilayer film, a second thermoplastic intermediate layer, and an inner pane.

The laminated pane is provided to separate the interior from the external environment in a window opening of a vehicle. Within the meaning of the invention, the term “inner pane” refers to the pane of the laminated pane facing the vehicle interior. Outer pane means the pane facing the external environment.

The laminated pane has an upper edge and a lower edge and two side edges extending between them. Upper edge means the edge intended to point upward in the installed position. Lower edge means the edge intended to point downward in the installed position. In the case of a windshield, the upper edge is often also referred to as the roof edge and the lower edge is referred to as the motor edge.

The outer pane and the inner pane each have an exterior-side and an interior-side surface and a peripheral side edge extending between them. In the context of the invention, the exterior-side surface means the main surface which is provided to face the external environment when installed. In the context of the invention, the interior-side surface means the main surface which is intended to face the interior space when installed. The interior-side surface of the outer pane and the exterior-side surface of the inner pane face one another and are connected to one another by the thermoplastic intermediate layer and the second thermoplastic intermediate layer.

The exterior-side surface of the outer pane is designated as side I. The interior-side surface of the outer pane is designated as side II. The exterior-side surface of the inner pane is designated as side III. The interior-side surface of the inner pane is designated as side IV.

According to the invention, the optical multilayer film has a portion designed as a concave mirror and is arranged between the outer pane and the inner pane.

The concave mirror is preferably a band-like, in particular cylindrical, concave mirror over substantially the entire width of the laminated pane with an axis of rotation in the y-direction according to the vehicle coordinate system. Accordingly, the projected image is enlarged only in the vertical direction by means of the concave mirror.

The first thermoplastic intermediate layer is arranged between the outer pane and the optical multilayer film, and the second thermoplastic intermediate layer is arranged between the optical multilayer film and the inner pane.

It should be understood that the first thermoplastic intermediate layer and the second thermoplastic intermediate layer are each arranged over the entire surface between the outer pane and the inner pane. Both the first thermoplastic intermediate layer and the second thermoplastic intermediate layer thus extend over the entire laminated pane.

The masking layer is arranged between the outer pane and the optical multilayer film in a region of the laminated pane.

At least the portion of the optical multilayer film designed as a concave mirror is arranged according to the invention in a region of the laminated pane which, when viewed perpendicularly through the laminated pane, lies completely within the region in which the masking layer is arranged. Thus, when viewed through the laminated pane from the inside, the masking layer is arranged at least behind the portion of the optical multilayer film designed as a concave mirror.

The expression “in the region in which the masking layer is arranged” means that the portion of the optical multilayer film designed as a concave mirror is arranged in a perpendicular view through the laminated pane or in an orthogonal projection through the pane covering or overlapping the masking layer. The portion of the optical multilayer film designed as a concave mirror has no portion which is not covering the masking layer, i.e., the concave mirror is formed only where it is in front of the masking layer when viewing the inner side of the laminated pane.

In a preferred embodiment, the optical multilayer film is arranged over the entire surface between the first thermoplastic intermediate layer and the second thermoplastic intermediate layer. The optical multilayer film thus extends over the entire surface of the laminated pane. Consequently, the optical multilayer film in this embodiment is also arranged over the entire surface between the outer pane and the inner pane. As described above, a portion of the optical multilayer film is designed as a concave mirror.

In an alternative preferred embodiment, the optical multilayer film is arranged only in a region of the laminated pane which, when viewed perpendicularly through the laminated pane, lies completely within the region in which the masking layer is arranged. In this embodiment, the optical multilayer film thus extends only over a partial surface of the laminated pane. As described above, a portion of the optical multilayer film is designed as a concave mirror. In this embodiment, the laminated pane additionally has a third thermoplastic intermediate layer which surrounds the optical multilayer film in the manner of a frame, i.e., the third thermoplastic intermediate layer has a recess in which the optical multilayer film is accommodated.

In this embodiment, the outer dimensions of the recess in the third thermoplastic intermediate layer substantially correspond to the outer dimensions of the optical multilayer film, i.e., the cutout and the optical multilayer film have substantially the same geometry.

Substantially the same external dimensions means that the outer dimensions deviate from one another by a maximum of 1 mm, preferably by a maximum of 50 μm (micrometers).

The third thermoplastic intermediate layer has a thickness which substantially corresponds to the thickness of the optical multilayer film, i.e., the optical multilayer film and the third thermoplastic intermediate layer have substantially the same thickness.

Substantially the same thickness means that the thicknesses deviates from one another by a maximum of 50 μm.

The optical multilayer film preferably comprises at least one first film with an exterior-side surface and an interior-side surface and a second film with an exterior-side surface and an interior-side surface, wherein the interior-side surface of the first film and the exterior-side surface of the second film face one another. A reflection layer for reflecting light is arranged between the first film and the second film at least in the portion of the optical multilayer film designed as a concave mirror. The reflection layer is preferably arranged only in the portion of the optical multilayer film which is designed as a concave mirror. Optionally, an adhesive layer, for example made of a thermoplastic film or an optically clear adhesive, can be arranged between the first film and the second film.

The reflection layer can be designed, for example, as a reflective coating of the interior-side surface of the first film or as a reflective coating of the exterior-side surface of the second film or as a reflective film.

In a preferred embodiment, the optical multilayer film comprises a first film with an exterior-side surface and an interior-side surface, and a second film with an exterior-side surface and an interior-side surface, wherein the interior-side surface of the first film and the exterior-side surface of the second film face one another. In the portion of the optical multilayer film designed as a concave mirror, the first film has a substantially plano-concave cross section and the second film has a substantially plano-convex cross section. In addition, a reflection layer for reflecting light is arranged between the first film and the second film at least in the portion of the optical multilayer film designed as a concave mirror. Optionally, an adhesive layer, for example made of a thermoplastic film or an optically clear adhesive, can be arranged between the first film and the second film.

In this embodiment, the reflection layer can be designed, for example, as a reflective coating of the interior-side surface of the first film or as a reflective coating of the exterior-side surface of the second film or as a reflective film.

In a further preferred embodiment, the optical multilayer film comprises a plurality of films, wherein a reflection layer for reflection of light is arranged in portions in the portion designed as a concave mirror between two adjacent films, and the reflection layers arranged in portions together define the concave mirror. The optical multilayer film thus has a structure comparable to a Fresnel lens in the portion designed as a concave mirror. Optionally, an adhesive layer, for example made of a thermoplastic film or an optically clear adhesive, can be arranged between two adjacent films.

In this embodiment, the reflection layer can be designed, for example, as a reflective coating.

As described above, the reflection layer is a reflection layer for reflecting light. The reflection layer is preferably light-impermeable or partially transparent, which within the meaning of the invention means that it has an average transmission (according to ISO 9050:2003) in the visible spectral range of preferably at most 80%, particularly preferably at most 50%, and in particular less than 10%. The reflective layer preferably reflects at least 10%, particularly preferably at least 50%, and very particularly preferably at least 80%, and in particular at least 90% of the light impinging upon the reflective layer. The reflective layer preferably reflects p-polarized and s-polarized light in equal proportions, but it can also reflect p-polarized light and s-polarized light to different degrees.

The light reflected by the reflective layer is preferably visible light, i.e., light in a wavelength range of approximately 380 nm to 780 nm. The reflective layer preferably has a high and uniform reflectance (via different irradiation angles) to p-polarized and/or s-polarized radiation, so that a strong and color-neutral image presentation is ensured.

The indication of the polarization direction refers to the plane of incidence of the radiation on the laminated pane. P-polarized radiation refers to a radiation the electric field of which oscillates in the plane of incidence. P-polarized radiation refers to a radiation the electric field of which oscillates perpendicular to the plane of incidence. The plane of incidence is spanned by the incident vector and the surface normal of the laminated pane in the geometric center of the irradiated region.

In other words, the polarization, i.e., in particular, the proportion of p-polarized and s-polarized radiation, is determined at a point of the region irradiated by the imaging unit—preferably in the geometric center of the irradiated region. Since laminated panes can be curved (for example, when configured as a windshield), which has effects upon the plane of incidence of the radiation, polarization components slightly deviating therefrom can occur in the other regions, which is unavoidable for physical reasons.

In a preferred embodiment of the invention, the reflection layer is a metallic layer, i.e., a layer which contains or consists of metal.

The reflective layer in this embodiment of the laminated pane according to the invention preferably contains at least one metal selected from a group consisting of aluminum, magnesium, tin, indium, titanium, tantalum, niobium, nickel, copper, chromium, cobalt, iron, manganese, zirconium, cerium, scandium, yttrium, silver, gold, platinum and palladium, ruthenium or mixtures thereof. Aluminum, titanium, and/or nickel are preferred because they can have a high reflection for p-polarized or s-polarized light. Aluminum in particular is preferred.

The reflective layer preferably has a thickness of 10 nm (nanometers) to 100 μm (micrometers), particularly preferably 50 nm to 50 μm, in particular 100 nm to 5 μm.

In a particularly preferred embodiment of the invention, the reflective layer is a coating containing a thin-film stack, i.e., a layer sequence of thin individual layers. This thin-film stack contains one or more electrically conductive layers based on nickel, titanium, and/or aluminum. The electrically conductive layer based on nickel, titanium, and/or aluminum gives the reflective layer basic reflective properties and also an IR-reflecting effect and an electrical conductivity. The electrically conductive layer is based on nickel, titanium, and/or aluminum. The conductive layer preferably contains at least 90 wt % nickel, titanium and/or aluminum, particularly preferably at least 99 wt % aluminum, and very particularly preferably at least 99.9 wt % nickel, titanium, and/or aluminum. The layer based on aluminum, nickel and/or titanium can have doping, for example, palladium, gold, copper, or silver. Materials based on aluminum, nickel, and/or titanium are particularly suitable for reflecting light, and particularly preferably p-polarized light. The use of nickel, titanium, and/or aluminum in metallic coatings has proven to be particularly advantageous in the reflection of light. Aluminum, nickel, and/or titanium are significantly cheaper than many other metals, such as gold or silver. The individual layers of the thin-film stack preferably have a thickness of 10 nm to 1 μm. The thin-film stack preferably has 2 to 20 individual layers and in particular 5 to 10 individual layers.

As described above, in embodiments, the reflection layer can be designed as a reflective film, in particular as a polyethylene terephthalate (PET), which is coated with a copolymer layer stack based on PET and/or polyethylene naphthalate (PEN). The coating is preferably applied to the interior-side surface, i.e., the surface that faces the vehicle interior. Suitable reflective films are described, for example, in U.S. Pat. No. 5,882,774 A.

As described above, in the laminated pane according to the invention a masking layer is arranged in one region of the laminated pane. The masking layer is preferably arranged in an edge region of the laminated pane, which is typically adjacent to the pane edge of the pane. The great advantage of this arrangement is obtained when using the laminated pane in a vehicle as a windshield, because the masking layer lies outside the main viewing area of the driver when arranged in an edge region.

The masking layer is preferably arranged at least along the lower edge and adjacent to the lower edge. This results in a rectangular opaque strip, which is arranged along the lower edge, when looking onto the laminated pane.

In a particularly preferred embodiment of the laminated pane according to the invention, the masking layer is designed to run peripherally in a frame-like manner. In a portion in which the region of the optical multilayer film designed as a concave mirror is arranged to cover the masking layer, the frame-like masking layer is preferably provided with a widening, i.e., it has a greater width (dimension perpendicular to the extension) than in other portions. In this way, the masking layer can be adapted in a suitable manner to the dimensions of the region of the optical multilayer film designed as a concave mirror.

In the installed state of the laminated pane in a vehicle, the region of the optical multilayer film designed as a concave mirror has a smaller distance from the vehicle interior than the masking layer.

Due to the fact that the region of the optical multilayer film designed as a concave mirror is arranged in a region of the laminated pane which, when viewed perpendicularly through the laminated pane, lies completely within the region in which the masking layer is arranged, the reflection layer arranged in this region is also arranged in a region which, in a perpendicular view through the laminated pane, lies completely within the region in which the masking layer is arranged. The reflection layer arranged in the region designed as a concave mirror is thus arranged in a perpendicular view through the laminated pane or in an orthogonal projection through the laminated pane covering the masking layer. The reflection layer preferably does not have a portion which does not cover the masking layer, i.e., the reflection layer is preferably formed only where it is in front of the masking layer in the viewing of the inside of the laminated pane.

The region of the optical multilayer film designed as a concave mirror preferably has substantially the shape of a rectangle which extends between the two side edges of the laminated pane in a region near the lower edge. Particularly preferably, the side edges of the optical multilayer film do not reach the side edges of the laminated pane, but instead are, for example, 2 cm to 5 cm distant from them.

The masking layer within the meaning of the invention is a layer that prevents the view through the laminated pane. In this case, at most 5%, preferably at most 2%, particularly preferably at most 1%, in particular at most 0.1%, of the light of the visible spectrum is transmitted through the masking layer. The masking layer is thus an opaque masking layer, preferably a black masking layer.

The masking layer is preferably a coating made up of one or more layers. Alternatively, the masking layer can also be an opaque film or a colored region of the thermoplastic intermediate layer. According to a preferred embodiment of the laminated pane, the masking layer consists of a single layer. This has the advantage of a particularly simple and cost-effective manufacture of the laminated pane because only a single layer has to be formed for the masking layer.

The masking layer is in particular an opaque masking print made of a dark, preferably black, enamel.

In a preferred embodiment, the masking layer is designed as an opaque masking print arranged on the interior-side surface of the outer pane, in particular made of a dark, preferably black, enamel.

In an alternative preferred embodiment, the masking layer is designed as an opaque masking print arranged between the first thermoplastic intermediate layer and the optical multilayer film, in particular made of a dark, preferably black, enamel, or formed as an opaque film arranged between the first thermoplastic intermediate layer and the optical multilayer film.

In an alternative preferred embodiment, the masking layer is designed as an opaquely colored region of the first thermoplastic intermediate layer.

In one embodiment, the first thermoplastic intermediate layer is formed in one piece and is opaquely colored in a region.

A masking layer designed as an opaquely colored region of the first thermoplastic intermediate layer can also be realized in which a first thermoplastic intermediate layer composed of an opaque thermoplastic film and a transparent thermoplastic film is used. The opaque thermoplastic film and the transparent thermoplastic film are preferably arranged offset from one another, so that the two films are not overlapping when looking through the laminated pane. The transparent thermoplastic film and the opaque thermoplastic film consist of the same plastic or preferably contain the same plastic. The materials on the basis of which the opaque thermoplastic film and the transparent thermoplastic film can be formed are those which are also described for the first thermoplastic intermediate layer. The opaque thermoplastic film is preferably a colored film which can have different colors, in particular black.

The masking layer can also be designed as an opaque film arranged between the outer pane and the first thermoplastic intermediate layer.

In a preferred embodiment of the laminated pane according to the invention, a highly refractive coating having a refractive index of at least 1.7 is arranged on the interior-side surface of the inner pane.

The highly refractive coating causes an increase in the refractive index of the interior-side surface of the inner pane. The Brewster angle α_{Brewster} is thereby increased at the interface, because said angle is known to be determined as

$${α}_{Brewster} = arctan ( \frac{{n}_{2}}{{n}_{1}} )$$

where n₁ is the refractive index of air, and n₂ is the refractive index of the material upon which the radiation impinges. The highly-refractive coating with the high refractive index leads to an increase in the effective refractive index of the glass surface and thus to a displacement of the Brewster angle towards larger values compared to an uncoated glass surface. As a result, with typical geometric relationships of HUD projection assemblies in vehicles, the difference between the angle of incidence and the Brewster angle becomes smaller, so that the reflection of p-polarized radiation on the interior-side surface is suppressed and a ghost image generated thereby is weakened.

In the context of the present invention, refractive indices are in all cases specified in relation to a wavelength of 550 nm. Methods for determining refractive indices are known to the person skilled in the art. The refractive indices specified within the scope of the invention can be determined, for example, by ellipsometry, wherein commercially available ellipsometers can be used. Unless otherwise indicated, the specification of layer thicknesses or thicknesses refers to the geometric thickness of a layer.

Suitable materials for a highly-refractive coating are silicon nitride (Si₃N₄), a silicon-metal mixed nitride (for example, silicon zirconium nitride (SiZrN), silicon-aluminum mixed nitride, silicon-hafnium mixed nitride, or silicon-titanium mixed nitride), aluminum nitride, tin oxide, manganese oxide, tungsten oxide, niobium oxide, bismuth oxide, titanium oxide, tin-zinc mixed oxide, and zirconium oxide. Furthermore, transition metal oxides (such as scandium oxide, yttrium oxide, tantalum oxide) or lanthanide oxides (such as lanthanum oxide or cerium oxide) can also be used. The highly-refractive coating preferably contains one or more of these materials or is formed on the basis thereof.

Suitable highly refractive coatings are disclosed, for example, in WO 2021/209201 A1.

In one embodiment of the laminated pane according to the invention, the main axis of the concave mirror is inclined relative to the orientation that is perpendicular to the laminated pane, so that the main plane of the concave mirror does not run parallel to the main plane of the laminated pane.

The laminated pane according to the invention can optionally additionally have an opaque masking print arranged on the interior-side surface of the inner pane, in particular a frame-like masking print in a peripheral edge region. Such a masking print on the interior-side surface of the inner pane improves the adhesion properties of the surface relative to an adhesive layer. The additional opaque masking print is preferably designed in the shape of a frame.

The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

The first thermoplastic intermediate layer and the second thermoplastic intermediate layer contain, independently of one another, at least one thermoplastic polymer, preferably ethylene vinyl acetate (EVA), polyvinyl butyral (PVB) or polyurethane (PU), or mixtures, or copolymers, or derivatives thereof, particularly preferably PVB. The first thermoplastic intermediate layer and the second thermoplastic intermediate layer are typically formed independently of one another from a thermoplastic film (joining film). The thickness of the first thermoplastic intermediate layer and that of the second thermoplastic intermediate layer are, independently of one another, preferably from 0.2 mm to 2 mm, particularly preferably from 0.3 mm to 1 mm. The first thermoplastic intermediate layer and the second thermoplastic intermediate layer can be formed in each case by a single film or else by more than one film. The first thermoplastic intermediate layer and/or the second thermoplastic intermediate layer can also be a film having functional properties, for example a film with acoustic damping properties.

The third thermoplastic intermediate layer independently contains at least one thermoplastic polymer, preferably ethylene vinyl acetate (EVA), polyvinyl butyral (PVB) or polyurethane (PU) or mixtures or copolymers or derivatives thereof, particularly preferably PVB. The third thermoplastic intermediate layer is typically formed from a thermoplastic film (joining film). As described above, the thickness of the third thermoplastic intermediate layer substantially corresponds to the thickness of the optical multilayer film. The third thermoplastic intermediate layer may be formed in each case by a single film or also by more than one film.

The individual films of the optical multilayer film contain or consist preferably independently of one another of polyethylene (PE), polycarbonates (PC), polypropylene (PP), polystyrene, polybutadiene, polynitriles, polyesters, in particular polyethylene terephthalate (PET), polyurethanes (PU), polymethyl methacrylate (PMMA), polyacrylates, polyamides (PA), acrylonitrile-butadiene-styrene copolymers (ABS), styrene-acrylonitrile copolymers (SAN), acrylic ester-styrene-acrylonitrile copolymers (ASA), acrylonitrile-butadiene-styrene-polycarbonate mixtures (ABS/PC) and/or copolymers, cocondensates and/or mixtures thereof. Particularly preferably, the individual films of the optical multilayer film contain or consist of PET.

The outer pane and the inner pane preferably contain or consist of glass, particularly preferably flat glass, float glass, quartz glass, borosilicate glass, soda-lime glass, alumino silicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can be clear and colorless, but also tinted or colored. In a preferred embodiment, the total transmission through a laminated pane designed as a windshield (together with a reflection layer) amounts to greater than 70% (light type A) in the main see-through region. The term total transmittance relates to the method defined by ECE-R 43, Annex 3, § 9.1 for testing the light transmittance of motor vehicle panes. Independently of one another, the outer pane and the inner panes can be not prestressed, partially prestressed or prestressed. If at least one of the panes should be prestressed, this can be thermal or chemical prestressing.

The thickness of the outer pane and of the inner pane can vary widely and accordingly be adapted to the requirements in the individual case. The outer pane and the inner pane preferably have thicknesses of 0.5 mm to 5 mm, particularly preferably of 1 mm to 3 mm, very particularly preferably of 1.6 mm to 2.1 mm. For example, the outer pane has a thickness of 2.1 mm, and the inner pane has a thickness of 1.6 mm. However, the outer pane or, in particular, the inner pane can also be thin glass with a thickness of 0.55 mm, for example.

The laminated pane according to the invention may comprise one or more additional intermediate layers, in particular functional intermediate layers. An additional intermediate layer can be, in particular an intermediate layer with acoustically damping properties, an intermediate layer reflecting infrared radiation, an intermediate layer absorbing infrared radiation, an intermediate layer absorbing UV radiation, a layer that is colored at least in portions, and/or an intermediate layer that is tinted at least in portions. If there is a plurality of additional intermediate layers, they can also have different functions.

The invention also relates to a projection assembly at least comprising a laminated pane according to the invention and an imaging unit directed onto the portion of the optical multilayer film designed as a concave mirror.

Also according to the invention, therefore, is a projection assembly at least comprising:
a laminated pane having an upper edge, a lower edge and two side edges, at least comprising an outer pane, a masking layer, a first thermoplastic intermediate layer, an optical multilayer film which has a portion designed as a concave mirror, a second thermoplastic intermediate layer, and an inner pane, wherein the optical multilayer film is arranged between the outer pane and the inner pane, the first thermoplastic intermediate layer is arranged between the outer pane and the optical multilayer film, the second thermoplastic intermediate layer is arranged between the optical multilayer film and the inner pane, the masking layer is arranged between the outer pane and the optical multilayer film in a region of the laminated pane, and wherein at least the portion of the optical multilayer film designed as a concave mirror is arranged in a region of the laminated pane that is completely within the region in which the masking layer is arranged when viewing through the laminated pane,
an imaging unit directed onto the portion of the optical multilayer film designed as a concave mirror.

The optical multilayer film can be constructed, for example, as described above.

In particular, the combination of the portion of the optical multilayer film designed as a concave mirror with the masking layer that is behind from the perspective of a vehicle occupant brings about good visibility of the image in the projection assembly according to the invention, even in the case of external solar radiation and when attenuated-light imaging units are used. Even under these circumstances, the image generated by the imaging unit appears bright and can be seen perfectly. This enables a reduction in the power of the imaging unit and thus a reduced energy consumption.

From the point of view of a vehicle occupant, the portion of the optical multilayer film designed as a concave mirror is arranged spatially in front of the masking layer when looking through the inner pane. The region of the laminated pane in which the portion of the optical multilayer film designed as a concave mirror is arranged is thereby opaque in effect. The expression “when looking through the laminated pane” means looking through the laminated pane starting from the interior-side surface of the laminated pane. Within the meaning of the present invention, “spatially in front of” means that the portion of the optical multilayer film designed as a concave mirror is arranged spatially further away from the exterior-side surface of the outer pane than the masking layer. Preferably, the masking layer is widened at least in the region which overlaps with the portion of the optical multilayer film formed as a concave mirror and is used in the laminated pane is used for displaying images. This means that when viewed perpendicular to the closest portion of the peripheral edge of the laminated pane, the masking layer in this region has a greater width than in other portions. In this way, the masking layer can be adapted to the dimensions of the portion of the optical multilayer film designed as a concave mirror.

The imaging unit of the projection assembly emits light and is arranged in the vicinity of the interior-side surface of the inner pane such that the imaging unit irradiates this surface, wherein the light is reflected by the portion of the optical multilayer film of the laminated pane designed as a concave mirror. The portion of the optical multilayer film designed as a concave mirror preferably reflects at least 10%, particularly preferably at least 50%, very particularly preferably at least 80%, and in particular at least 90% of the incident light in a wavelength range of 400 nm to 700 nm and irradiation angles of 55° to 80° on the laminated pane. This is advantageous in order to achieve the greatest possible brightness of an image emitted by the imaging unit and reflected by the portion of the optical multilayer film that is designed as a concave mirror.

The imaging unit serves to emit an image and can thus also be referred to as a projector, display device or image display device. A display or other device known to a person skilled in the art, for example, can be used as the imaging unit. The imaging unit is preferably a display, particularly preferably an LCD display, LED display, OLED display, micro-LED display or electroluminescent display, in particular an LCD display. Displays have a low installation height and are thus simply integrated into the dashboard of a vehicle in a space-saving manner. Moreover, displays can be operated in a significantly more energy-saving manner than other imaging units. The comparatively lower brightness of displays is completely sufficient in the combination according to the invention of the portion of the optical multilayer film designed as a concave mirror and with the mask layer located behind it. The radiation of the imaging unit preferably impinges at an angle of incidence of 55° to 80°, preferably from 62° to 77°, on the main plane of the portion of the optical multilayer film designed as a concave mirror. The angle of incidence is the angle between the incident vector of the radiation of the image display device and the optical axis, i.e., the surface normal in the geometric center of the main plane of the portion of the optical multilayer film designed as a concave mirror.

The imaging unit is arranged in particular within the simple focal length of the portion of the optical multilayer film designed as a concave mirror. In such an arrangement, the virtual image is enlarged in the vertical direction compared to the image emitted by the imaging unit. For example, the virtual image has a size of 150% compared to the image emitted by the imaging unit. Smaller imaging units can thus be used to generate a virtual image in a certain size. Smaller imaging units are characterized by a lower energy consumption and also offer greater flexibility with regard to placement in the dashboard. These are advantages of the projection assembly according to the invention.

As described above, in the laminated pane according to the invention, the main axis of the concave mirror can be inclined relative to the orientation that is perpendicular to the laminated pane so that the main plane of the concave mirror does not run parallel to the main plane of the laminated pane. In such embodiments, the angle of inclination of the laminated pane thus differs from the angle of inclination of the main plane of the concave mirror. Such a decoupling of the angle of inclination of the laminated pane from the angle of inclination of the main plane of the concave mirror enables more freedom with regard to placement of the imaging unit in the dashboard. This is a further advantage of the laminated pane according to the invention and the projection assembly according to the invention.

The preferred embodiments of the laminated pane according to the invention described above also correspondingly apply for the projection assembly according to the invention comprising a laminated pane according to the invention and an imaging unit and vice versa.

According to the invention, there is also a method for producing a laminated pane according to the invention comprising at least:
a) providing an outer pane with an exterior-side surface and an interior-side surface, a first thermoplastic intermediate layer, a second thermoplastic intermediate layer, an inner pane with an exterior-side surface and an interior-side surface and an optical multilayer film, which has a portion designed as a concave mirror;
b) forming a layer stack in which the optical multilayer film is arranged between the outer pane and the inner pane, the first thermoplastic intermediate layer is arranged between the outer pane and the optical multilayer film, the second thermoplastic intermediate layer is arranged between the optical multilayer film and the inner pane, a masking layer is arranged between the outer pane and the optical multilayer film in a region of the laminated pane, and wherein at least the portion of the optical multilayer film designed as a concave mirror is arranged in a region of the laminated pane which, when viewed perpendicularly through the laminated pane, lies completely within the region in which the masking layer is arranged;
c) joining the layer stack by lamination.

It should be understood that the steps are carried out in the order a), b), c).

As described above, the optical multilayer film having a portion designed as a concave mirror can comprise a first film with an exterior-side surface and an interior-side surface and a second film with an exterior-side surface and an interior-side surface, wherein the interior-side surface of the first film and the exterior-side surface of the second film face one another, and wherein, in the portion designed as a concave mirror, the first film has a substantially plano-concave cross section, the second film has a substantially plano-convex cross section, and a reflection layer for reflection of light is arranged between the first film and the second film. Such an optical multilayer film can be produced, for example, in which the first film and the second film are produced independently of one another by means of an injection molding process or thermoforming, and a reflection layer is then applied as a coating to the interior-side surface of the first film or to the exterior-side surface of the second film, or a reflection layer in the form of a reflective film is arranged between the first film and the second film. Optionally, an adhesive layer, for example made of an optically clear adhesive, can additionally be arranged over the entire surface between the first film and the second film.

As described above, the optical multilayer film having a portion designed as a concave mirror can comprise in a further embodiment a plurality of films, wherein a reflection layer for reflection of light is arranged in portions between two adjacent films in the portion designed as a concave mirror, and the reflection layers arranged in portions together define the concave mirror. Such an optical multilayer film can be produced, for example, in which the films are produced independently of one another by means of an injection molding process or thermoforming. The reflection layer can be introduced, for example, as a coating of the individual films in portions. Optionally, an adhesive layer, for example made of an optically clear adhesive, can additionally be arranged over the entire surface between two adjacent films.

The application of a reflection layer as a coating can take place by means of generally known coating methods, such as magnetron sputtering or cold gas spraying.

The layer stack can be joined in step c) by means of lamination methods familiar to a person skilled in the art. For example, so-called autoclave methods can be carried out at an elevated pressure of approximately 10 bar to 15 bar and at temperatures of 130° C. to 145° C. for approximately 2 hours. Alternatively, methods without autoclaving are also possible. Vacuum bag or vacuum ring methods known per se operate, for example, at approximately 200 mbar and 80° C. to 110° C. The layer stack may also be pressed in a calender between at least one pair of rollers to form a laminated pane. Systems of this type are known for producing panes and normally have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of the layer stack is laminated within, for example, approximately 60 minutes at reduced pressures of 0.01 mbar to 800 mbar and temperatures of 80° C. to 170° C.

In embodiments in which the optical multilayer film is arranged only in a region of the laminated pane which, when viewed perpendicularly through the laminated pane, is completely within the region in which the masking layer is arranged, and the laminated pane additionally has a third thermoplastic intermediate layer which surrounds the optical multilayer film in the manner of a frame, step a) additionally comprises providing a third thermoplastic intermediate layer which has a recess and step b) additionally comprises arranging the third thermoplastic intermediate layer between the first and the second thermoplastic intermediate layer and arranging the optical multilayer film in the recess of the third thermoplastic intermediate layer.

The preferred embodiments of the laminated pane according to the invention described above also correspondingly apply to methods for producing a laminated pane according to the invention.

The invention also relates to the use of a laminated pane according to the invention as a vehicle pane in a means of transport for traffic on land, in the air or on water, in particular in motor vehicles and in particular as a windshield for a head-up display.

In the following, the invention is explained in more detail with the aid of drawings and examples of embodiments. The drawings are schematic representations and are not true to scale. The drawings do not limit the invention in any way.

In the figures:

FIG. 1 shows a plan view of an embodiment of a laminated pane according to the invention,

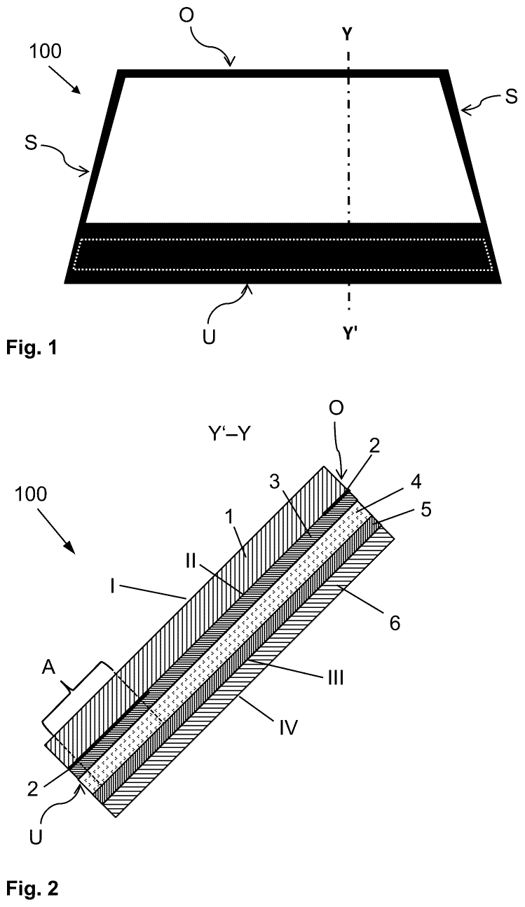

FIG. 2 shows a cross section through the embodiment shown in FIG. 1,

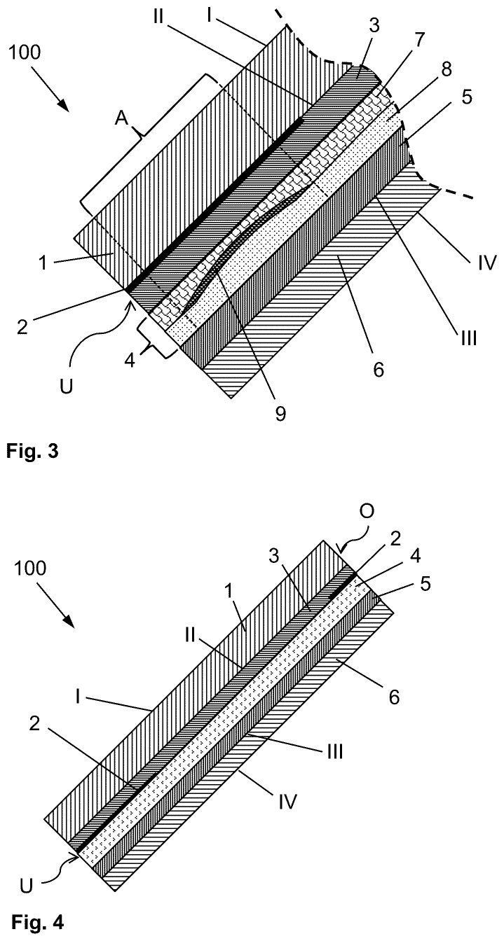

FIG. 3 shows a detail of the cross section shown in FIG. 2,

FIG. 4 shows a cross section through a further embodiment of a laminated pane according to the invention,

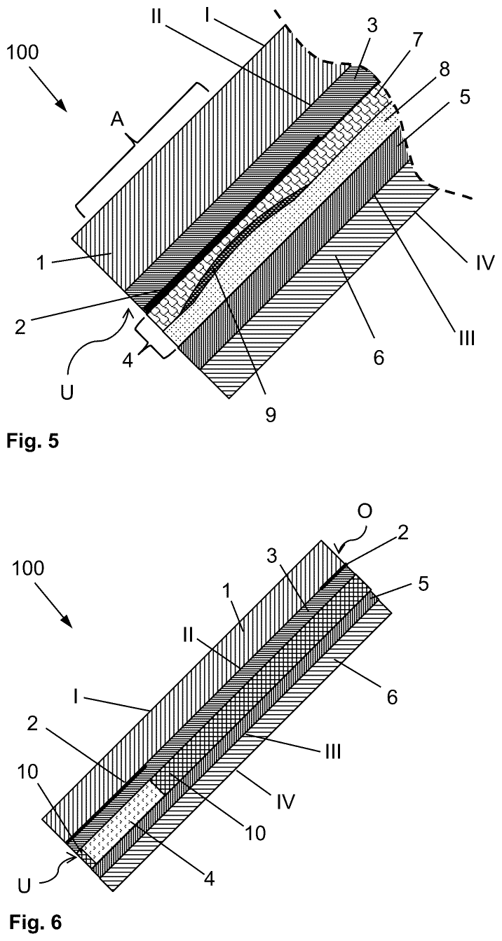

FIG. 5 shows a detail of the cross section shown in FIG. 4,

FIG. 6 shows a cross section through a further embodiment of a laminated pane according to the invention,

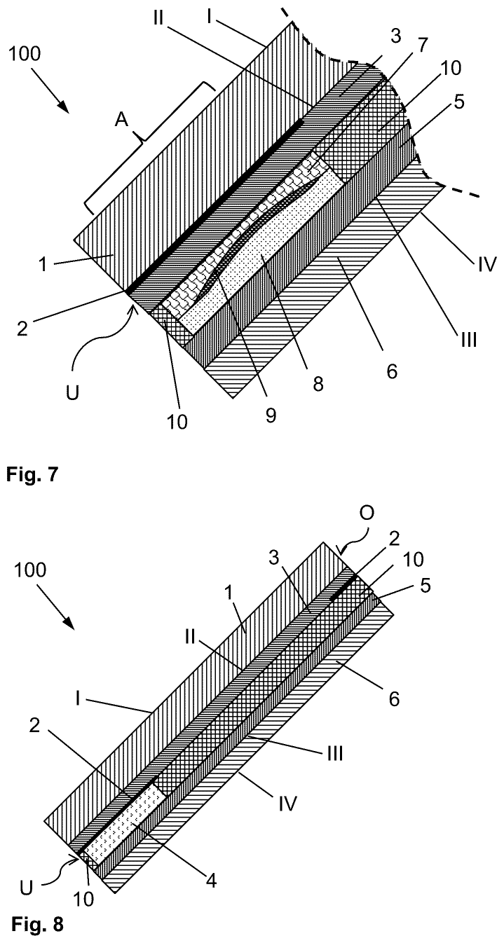

FIG. 7 shows a detail of the cross section shown in FIG. 6,

FIG. 8 shows a cross section through a further embodiment of a laminated pane according to the invention,

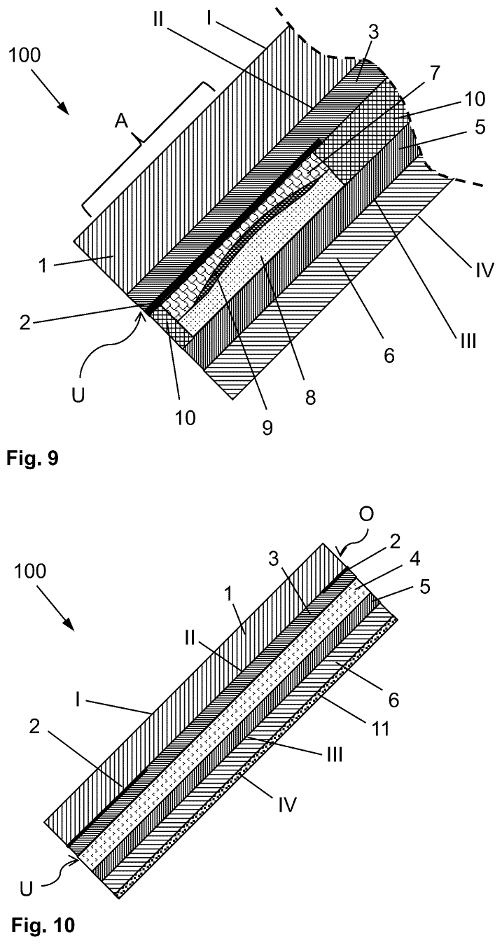

FIG. 9 shows a detail of the cross section shown in FIG. 8,

FIG. 10 shows a cross section through a further embodiment of a laminated pane according to the invention,

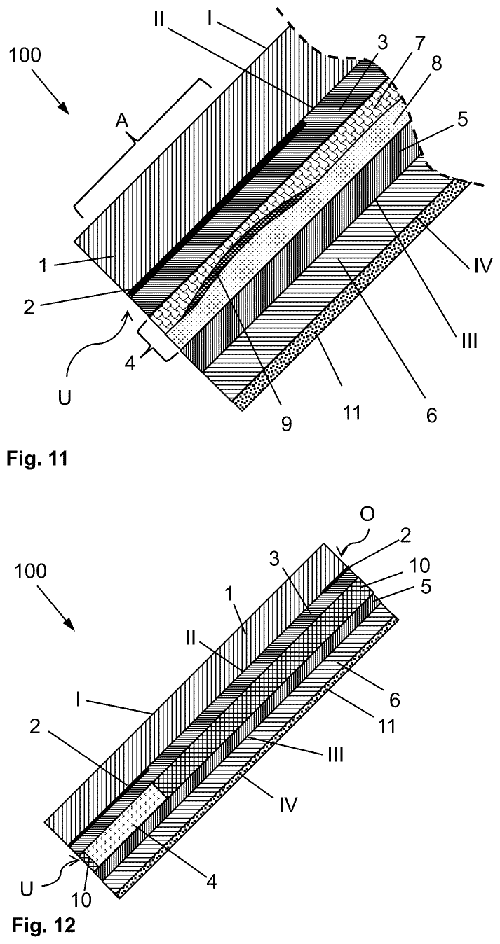

FIG. 11 shows a detail of the cross section shown in FIG. 10,

FIG. 12 shows a cross section through a further embodiment of a laminated pane according to the invention,

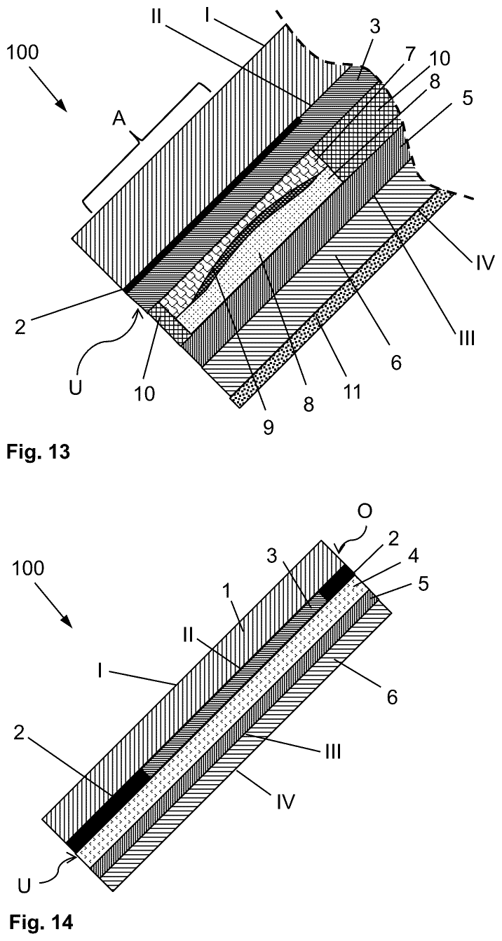

FIG. 13 shows a detail of the cross section shown in FIG. 12,

FIG. 14 shows a cross section through a further embodiment of a laminated pane according to the invention,

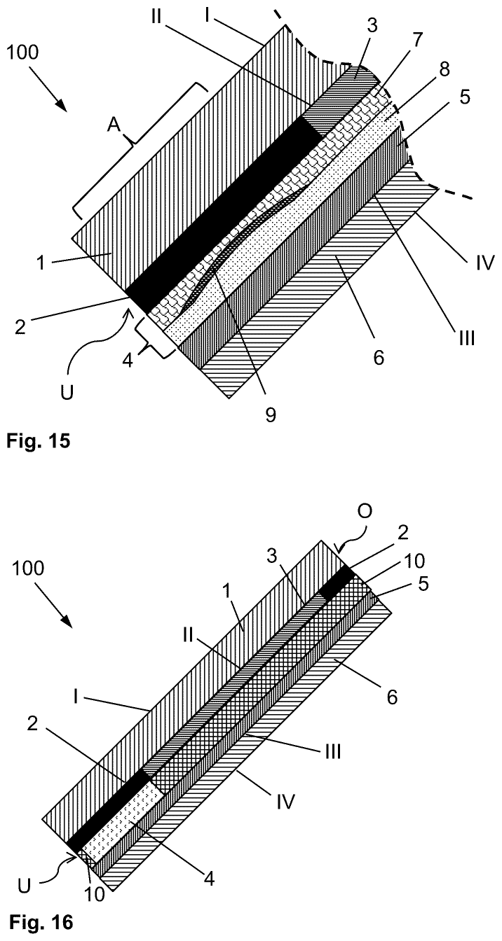

FIG. 15 shows a detail of the cross section shown in FIG. 14,

FIG. 16 shows a cross section through a further embodiment of a laminated pane according to the invention,

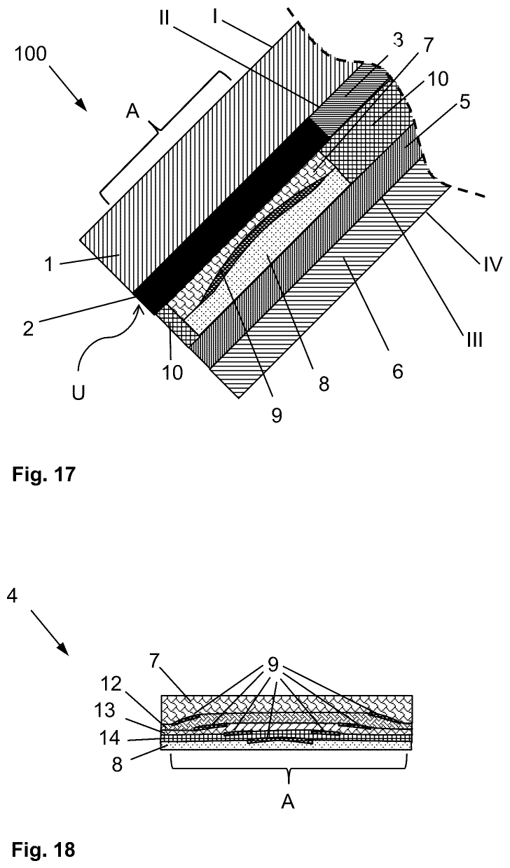

FIG. 17 shows a detail of the cross section shown in FIG. 16,

FIG. 18 shows a cross section of an embodiment of an optical multilayer film,

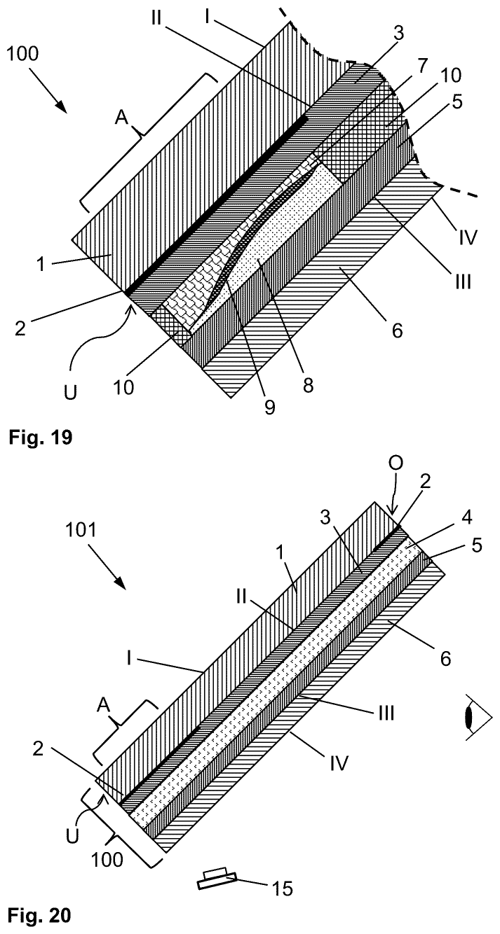

FIG. 19 shows a detail of a cross section of a further embodiment of a laminated pane according to the invention,

FIG. 20 shows a cross section through an embodiment of a projection assembly according to the invention, and

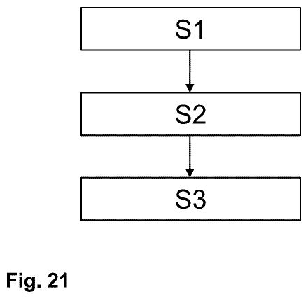

FIG. 21 shows an exemplary embodiment of a method according to the invention using a flow chart.

FIG. 1 shows a plan view of an embodiment of a laminated pane 100 according to the invention, and in FIG. 2 the cross section through the laminated pane 100 shown in FIG. 1 along the cutting line Y-Y′ is shown. The laminated pane 100 shown in FIGS. 1 and 2 has an upper edge O, a lower edge U and two side edges S and comprises an outer pane 1 with an exterior-side surface I and an interior-side surface II, an inner pane 6 with an exterior-side surface III and an interior-side surface IV, a first thermoplastic intermediate layer 3, a masking layer 2, an optical multilayer film 4, and a second thermoplastic intermediate layer 5. The optical multilayer film 4 is arranged between the outer pane 1 and the inner pane 6, the first thermoplastic intermediate layer 3 is arranged between the outer pane 1 and the optical multilayer film 4, and the second thermoplastic intermediate layer 5 is arranged between the optical multilayer film 4 and the inner pane 6. The outer pane 1, the first thermoplastic intermediate layer 3, the optical multilayer film, the second thermoplastic intermediate layer 5 and the inner pane 6 are arranged over one another over the entire surface in the embodiment shown in FIGS. 1 and 2. The masking layer 2 is arranged between the outer pane 1 and the optical multilayer film 4 in a region of the laminated pane 100. In the embodiment shown in FIGS. 1 and 2, the masking layer 2 is designed as an opaque masking print made of a black enamel which is arranged on the interior-side surface II of the outer pane 1 and is arranged in a peripheral edge region which has a greater width in the region of the lower edge than in portions different therefrom.

The optical multilayer film 4 has a portion A designed as a concave mirror, wherein this portion A of the optical multilayer film 4 is arranged in a region of the laminated pane 100 which, when viewed perpendicularly through the laminated pane 100, lies completely within the region in which the masking layer 2 is arranged. In FIG. 1, the portion A is bordered by a white dotted line to illustrate the position of the portion A. The concave mirror formed in portion A is thus not a spherical concave mirror as described in WO 2020/136646 A1, but instead is a band-like concave mirror, for example a cylindrical concave mirror, which extends substantially over the entire width of the laminated pane 100.

The first thermoplastic intermediate layer 3 and the second thermoplastic intermediate layer 5 contain, for example, PVB and each have a thickness of 0.38 mm. The outer pane 1 consists, for example, of soda lime glass and is 2.1 mm thick. The inner pane 6 consists, for example, of soda lime glass and is 1.6 mm thick.

It should be understood that the laminated pane 100 can have any suitable geometric shape and/or curvature. Typically, the laminated pane 100 is a curved laminated pane.

FIG. 3 shows a detail of the cross section shown in FIG. 2 of an embodiment of a laminated pane 100 according to the invention, in which the structure of the optical multilayer film 4 is shown in more detail. In the embodiment shown in FIG. 3, the optical multilayer film 4 has a first film 7 with an exterior-side surface and an interior-side surface, and a second film 8 with an exterior-side surface and an interior-side surface, and the interior-side surface of the first film 7 and the exterior-side surface of the second film 8 face one another. In the portion A designed as a concave mirror, the first film 7 has a plano-concave cross section and in the other portions a rectangular cross section. In the portion A designed as a concave mirror, the second film 8 has a plano-convex cross section and in the other portions a rectangular cross section. In addition, a reflection layer 9 for reflecting light is arranged in the portion A designed as a concave mirror between the first film 7 and the second film 8.

The first film 7 and the second film 8 consist, for example, of PET, and the optical multilayer film 4 has, for example, a total thickness of 2 mm. Optionally, the first film 7 and the second film 8 can be joined to one another via an adhesive layer, for example in the form of an optically clear adhesive (OCA).

The reflection layer 9 is, for example, a metallic layer with a thickness of 100 nm and contains aluminum.

FIG. 4 shows a cross section through a further embodiment of a laminated pane 100 according to the invention, and FIG. 5 shows a detail of the cross section shown in FIG. 4. The embodiment shown in cross section in FIG. 4 and FIG. 5 differs from that shown in FIG. 2 and FIG. 3 only in that the masking layer 2 is not designed as an opaque masking print arranged on the interior-side surface II of the outer pane 1, but instead is designed as an opaque masking print arranged between the first thermoplastic intermediate layer 3 and the optical multilayer film 4 or as an opaque film arranged between the first thermoplastic intermediate layer 3 and the optical multilayer film 4.

FIG. 6 shows a cross section through a further embodiment of a laminated pane 100 according to the invention, and FIG. 7 shows a detail of the cross section shown in FIG. 6. The embodiment shown in cross section in FIG. 6 and FIG. 7 differs from that shown in FIG. 2 and FIG. 3 only in that the optical multilayer film 4 is not arranged over the entire surface between the outer pane 1 and the inner pane 6, but instead is arranged only in a region of the laminated pane 100 which, when viewed perpendicularly through the laminated pane 100, is completely within the region in which the masking layer 2 is arranged, and the laminated pane 100 additionally has a third thermoplastic intermediate layer 10 which surrounds the optical multilayer film 4 in a frame-like manner. The third thermoplastic intermediate layer 10 contains, for example, PVB and has a thickness which corresponds to the thickness of the optical multilayer film 4. The third thermoplastic intermediate layer 10 has a recess in which the optical multilayer film 4 is accommodated.

FIG. 8 shows a cross section through a further embodiment of a laminated pane 100 according to the invention, and FIG. 9 shows a detail of the cross section shown in FIG. 8. The embodiment shown in cross section in FIG. 8 and FIG. 9 differs from that shown in FIG. 6 and FIG. 7 only in that the masking layer 2 is not designed as an opaque masking print arranged on the interior-side surface II of the outer pane 1, but instead is designed as an opaque masking print arranged between the first thermoplastic intermediate layer 3 and the optical multilayer film 4 or as an opaque film arranged between the first thermoplastic intermediate layer 3 and the optical multilayer film 4.

FIG. 10 shows a cross section through a further embodiment of a laminated pane 100 according to the invention, and FIG. 11 shows a detail of the cross section shown in FIG. 10. The embodiment shown in cross section in FIG. 10 and FIG. 11 differs from that shown in FIG. 2 and FIG. 3 only in that in the laminated pane 100 is additionally arranged with a refractive index of at least 1.7 a highly refractive coating 11 arranged on the interior-side surface IV of the inner pane 6. The highly refractive coating 11 is designed, for example, as a single layer based on titanium oxide (refractive index 2.4) with a layer thickness of 70 nm, which layer is applied by means of a sol-gel method.

FIG. 12 shows a cross section through a further embodiment of a laminated pane 100 according to the invention, and FIG. 13 shows a detail of the cross section shown in FIG. 12. The embodiment shown in cross section in FIG. 12 and FIG. 13 differs from that shown in FIG. 6 and FIG. 7 only in that in the laminated pane 100 is additionally arranged with a refractive index of at least 1.7 a highly refractive coating 11 arranged on the interior-side surface IV of the inner pane 6. The highly refractive coating 11 is designed, for example, as a single layer based on titanium oxide (refractive index 2.4) with a layer thickness of 70 nm, which layer is applied by means of a sol-gel method.

FIG. 14 shows a cross section through a further embodiment of a laminated pane 100 according to the invention, and FIG. 15 shows a detail of the cross section shown in FIG. 14. The embodiment shown in cross section in FIG. 14 and FIG. 15 differs from that shown in FIG. 2 and FIG. 3 only in that the masking layer 2 is not designed as an opaque masking print arranged on the interior-side surface II of the outer pane 1, but instead is designed as an opaquely colored region of the first thermoplastic intermediate layer 3.

FIG. 16 shows a cross section through a further embodiment of a laminated pane 100 according to the invention, and FIG. 17 shows a detail of the cross section shown in FIG. 16. The embodiment shown in cross section in FIG. 16 and FIG. 17 differs from that shown in FIG. 6 and FIG. 7 only in that the masking layer 2 is not designed as an opaque masking print arranged on the interior-side surface II of the outer pane 1, but instead is designed as an opaquely colored region of the first thermoplastic intermediate layer 3.

FIG. 18 shows a cross section of an embodiment of an optical multilayer film 4. In the embodiment shown in FIG. 18, the optical multilayer film 4 has a first film 7, a second film 8, and three further films which are provided with the reference signs 12, 13, and 14. In the portion A designed as a concave mirror, a reflection layer 9 for reflection of light is arranged in each case in portions between two adjacent films, and the reflection layers 9 arranged in portions together define the concave mirror.

The films 7, 8, 12, 13 and 14 consist, for example, of PET, and the optical multilayer film 4 has, for example, a total thickness of 2 mm. Optionally, adjacent films of the films 7, 8, 12, 13 and 14 can be joined to one another via an adhesive layer, for example in the form of an optically clear adhesive (OCA).

It should be understood that in laminated panes 100 according to the invention with a structure as shown in FIGS. 6, 8, 12 and 16, the optical multilayer film 4 does not have to be constructed as shown in FIGS. 7, 9, 13 and 17, but instead can also be designed, for example, as in FIG. 18. Also with laminated panes 100 according to the invention having a structure as shown in FIGS. 2, 4, 10 and 14, the optical multilayer film 4 does not have to be constructed as shown in FIGS. 3, 5, 11, and 15, but instead can also be designed from more than two films.

FIG. 19 shows a detail of a further embodiment of a laminated pane 100 according to the invention. The embodiment shown in FIG. 19 differs from that shown in FIG. 3 only in that the main axis of the concave mirror does not correspond to the orientation that is perpendicular to the laminated pane 100, but instead is inclined relative to the orientation that is perpendicular to the laminated pane.

FIG. 20 shows a cross section through an embodiment of a projection assembly 101 according to the invention. The projection assembly 101 shown in FIG. 20 comprises a laminated pane 100 and an imaging unit 15.

The laminated pane 100 is designed as shown in FIG. 2 and has an upper edge O, a lower edge U and two side edges S and comprises an outer pane 1 with an exterior-side surface I and an interior-side surface II, an inner pane 6 with an exterior-side surface Ill and an interior-side surface IV, a first thermoplastic intermediate layer 3, a masking layer 2, an optical multilayer film 4, and a second thermoplastic intermediate layer 5. The optical multilayer film 4 is arranged between the outer pane 1 and the inner pane 6, the first thermoplastic intermediate layer 3 is arranged between the outer pane 1 and the optical multilayer film 4, and the second thermoplastic intermediate layer 5 is arranged between the optical multilayer film 4 and the inner pane 6. The outer pane 1, the first thermoplastic intermediate layer 3, the optical multilayer film 4, the second thermoplastic intermediate layer 5, and the inner pane 6 are arranged over the entire surface. The masking layer 2 is arranged between the outer pane 1 and the optical multilayer film 4 in a region of the laminated pane 100. The masking layer 2 is designed as an opaque masking print which is arranged on the interior-side surface II of the outer pane 1, is made of a black enamel and is arranged in a peripheral edge region which has a greater width in the region of the lower edge than in portions different therefrom.

The optical multilayer film 4 has a portion A designed as a concave mirror, wherein this portion A of the optical multilayer film 4 is arranged in a region of the laminated pane 100 which, when viewed perpendicularly through the laminated pane 100, lies completely within the region in which the masking layer 2 is arranged.

The first thermoplastic intermediate layer 3 and the second thermoplastic intermediate layer 5 contain, for example, PVB and each have a thickness of 0.38 mm. The outer pane 1 consists, for example, of soda lime glass and is 2.1 mm thick. The inner pane 6 consists, for example, of soda lime glass and is 1.6 mm thick.

It should be understood that the laminated pane 100 can have any suitable geometric shape and/or curvature. Typically, the laminated pane 100 is a curved laminated pane.

The laminated pane 100 is, for example, the windshield of a motor vehicle.

The projection assembly 101 has an imaging unit 15. The imaging unit 15 serves to generate p-polarized light and/or s-polarized light (image information), which is directed onto the portion A of the optical multilayer film 4 designed as a concave mirror and is reflected from there in the direction of the observer, where it can be perceived by a viewer, e. g., driver. The portion A of the optical multilayer film 4, which portion is designed as a concave mirror, is suitably designed to reflect the light of the imaging unit 15, i.e., an image formed by the light of the imaging unit 15. The light preferably impinges on the laminated pane 100 at an angle of incidence of 55° to 80°, in particular of 62° to 77°. The imaging unit 15 is, for example, a display, in particular an LCD display.

An exemplary embodiment of a method according to the invention is shown in FIG. 21 using a flow chart.

In a first step S1, an outer pane 1 having an exterior-side surface I and an interior-side surface II, a first thermoplastic intermediate layer 3, a second thermoplastic layer 5, an inner pane 6 having an exterior-side surface III and an interior-side surface IV and an optical multilayer film 4, which has a portion A designed as a concave mirror, are provided.

In a second step S2, a layer stack is formed in which the optical multilayer film 4 is arranged between the outer pane 1 and the inner pane 6, the first thermoplastic intermediate layer 3 is arranged between the outer pane 1 and the optical multilayer film 4, the second thermoplastic intermediate layer 5 is arranged between the optical multilayer film 4 and the inner pane 6, a masking layer 2 is arranged between the outer pane 1 and the optical multilayer film 4 in a region of the laminated pane 100, and wherein at least the portion A of the optical multilayer film 4 designed as a concave mirror is arranged in a region of the laminated pane 100 which, when viewed perpendicularly through the laminated pane 100, is completely within the region in which the masking layer 2 is arranged.

In a third step S3, the layer stack is joined by lamination.

### EXAMPLE

In a projection assembly according to the invention with the parameters given below which comprises a laminated pane according to the invention and an imaging unit, the virtual image has a size of 150% compared to the image emitted by the imaging unit.

Radius of curvature of the portion of the optical multilayer film designed as a concave mirror: 400 mm
Distance of eye of the viewer—apex of the concave mirror: 800 mm
Distance of apex of the concave mirror—virtual image: 215 mm
Distance of apex of the concave mirror—imaging unit: 128.8 mm
Angle of incidence on the portion of the optical multilayer film designed as a concave mirror: 50°
Angle of incidence on the laminated pane: 62°

In the context of this invention, the term “apex of the concave mirror” denotes the piercing point of the central optical path in the geometric center of the main plane of the concave mirror.

In this projection assembly according to the invention, an observer sees a 66.6 mm high image radiated by the imaging unit as a virtual image with a height of 100 mm.

### LIST OF REFERENCE SIGNS

100 Laminated pane
101 Projection assembly
1 Outer pane
2 Masking layer
3 First thermoplastic intermediate layer
4 Optical multilayer film
5 Second thermoplastic intermediate layer
6 Inner pane
7 First film
8 Second film
9 Reflective layer
10 Third thermoplastic intermediate layer
11 Highly refractive coating
12 Film
13 Film
14 Film
15 Imaging unit
O Upper edge of the laminated pane 100
U Lower edge of the laminated pane 100
S Side edge of the laminated pane 100
I Exterior-side surface of the outer pane 1
II Interior-side surface of the outer pane 1
III Exterior-side surface of the inner pane 6
IV Interior-side surface of the inner pane 6
A Portion of the optical multilayer film 4 designed as a concave mirror
Y-Y′ Cutting line

1. A laminated pane having an upper edge, a lower edge and two side edges, comprising:
an outer pane with an exterior-side surface and an interior-side surface,
a masking layer,
a first thermoplastic intermediate layer,
an optical multilayer film which has a portion designed as a concave mirror,
a second thermoplastic intermediate layer, and
an inner pane with an exterior-side surface and an interior-side surface,
wherein the optical multilayer film is arranged between the outer pane and the inner pane,
the first thermoplastic intermediate layer is arranged between the outer pane and the optical multilayer film,
the second thermoplastic intermediate layer is arranged between the optical multilayer film and the inner pane,
the masking layer is arranged between the outer pane and the optical multilayer film in a region of the laminated pane,
and wherein at least the portion of the optical multilayer film designed as a concave mirror is arranged in a region of the laminated pane which, when viewed perpendicularly through the laminated pane, lies completely in the region in which the masking layer is arranged.

2. The laminated pane according to claim 1, wherein the optical multilayer film is arranged over an entire surface between the outer pane and the inner pane.

3. The laminated pane according to claim 1, wherein the optical multilayer film is arranged in a region of the laminated pane which, when viewed perpendicularly through the laminated pane, is completely in the region in which the masking layer is arranged, and the laminated pane additionally has a third thermoplastic intermediate layer which surrounds the optical multilayer film in a frame-like manner.

4. The laminated pane according to claim 1, wherein the optical multilayer film comprises a first film having an exterior-side surface and an interior-side surface, and a second film having an exterior-side surface and an interior-side surface, and the interior-side surface of the first film and the exterior-side surface of the second film face one another,
and wherein the first film has a substantially plano-concave cross section in the portion designed as a concave mirror, the second film has a substantially plano-convex cross section and, at least in the portion designed as a concave mirror, a reflection layer for reflection of light is arranged between the first film and the second film.

5. The laminated pane according to claim 1, wherein the optical multilayer film comprises a plurality of films, a reflection layer for reflection of light is arranged in each case between two adjacent films in the portion formed as a concave mirror, and the reflection layers arranged in portions together define the concave mirror.

6. The laminated pane according to claim 4, wherein the reflection layer reflects at least 10% of visible light.

7. The laminated pane according to claim 4, wherein the reflection layer has an average transmission in the visible spectral range of at most 50%.

8. The laminated pane according to claim 1, wherein the masking layer is designed to run peripherally in a frame-like manner and, in a portion which overlaps the portion of the optical multilayer film designed as a concave mirror, has a greater width than in portions different therefrom.

9. The laminated pane according to claim 1, wherein the masking layer is designed as an opaque masking print arranged on the interior-side surface of the outer pane, or the masking layer is designed as an opaque masking print arranged between the first thermoplastic intermediate layer and the optical multilayer film or as an opaque film arranged between the first thermoplastic intermediate layer and the optical multilayer film.

10. The laminated pane according to claim 1, wherein the masking layer is designed as an opaquely colored region of the first thermoplastic intermediate layer.

11. The laminated pane according to claim 1, wherein a highly refractive coating having a refractive index of at least 1.7 is arranged on the interior-side surface of the inner pane.

12. The laminated pane according to claim 1, wherein a main axis of the concave mirror is inclined relative to the orientation that is perpendicular to the laminated pane.

13. A projection assembly comprising:
a laminated pane according to claim 1,
an imaging unit directed onto the portion of the optical multilayer film that is designed as a concave mirror.

14. A method for producing a laminated pane according to claim 1, comprising:
a) providing an outer pane with an exterior-side surface and an interior-side surface, a first thermoplastic intermediate layer, a second thermoplastic intermediate layer, an inner pane having an exterior-side surface and an interior-side surface and an optical multilayer film, which has a portion designed as a concave mirror;
b) forming a layer stack in which the optical multilayer film is arranged between the outer pane and the inner pane, the first thermoplastic intermediate layer is arranged between the outer pane and the optical multilayer film, the second thermoplastic intermediate layer is arranged between the optical multilayer film and the inner pane, a masking layer is arranged between the outer pane and the optical multilayer film in a region of the laminated pane, and wherein at least the portion of the optical multilayer film designed as a concave mirror is arranged in a region of the laminated pane which, when viewed perpendicularly through the laminated pane, is completely within the region in which the masking layer is arranged;
c) joining the layer stack by lamination.

15. A method comprising providing a laminated pane according to claim 1 as a vehicle pane in means of transport for traffic on land, in the air or on water.

16. The laminated pane according to claim 6, wherein the reflection layer reflects at least 50% of visible light.

17. The laminated pane according to claim 16, wherein the reflection layer reflects at least 80% of visible light.

18. The laminated pane according to claim 16, wherein the reflection layer reflects at least 90% of visible light.

19. The laminated pane according to claim 7, wherein the reflection layer has an average transmission in the visible spectral range of less than 10%.

20. The method according to claim 15, wherein the laminated pane is a windshield for a head-up display.
